(19) United States
(12) Patent Application Publication
(10) Pub. No.: US 2003/0174147 A1
(43) Pub. Date: Sep. 18, 2003

(54) Device, system and method for simulating a physical system

(76) Inventor: David Jaffe, Ra'anana (IL)

Correspondence Address: EITAN, PEARL, LATZER & COHEN ZEDEK LLP, 10 ROCKEFELLER PLAZA, SUITE 1001, NEW YORK, NY, 10020, US

(21) Appl. No.: 10/365,611

(22) Filed: Feb. 13, 2003

Related U.S. Application Data
(63) Continuation-in-part of application No. 10/217,331, filed on Aug. 13, 2002.
(63) Continuation-in-part of application No. PCT/US02/41865, filed on Aug. 13, 2002.
(60) Provisional application No. 60/311,800, filed on Aug. 13, 2001.

(51) Int. Cl. G09G 5/00

(52) U.S. Cl. 345/633

(57) ABSTRACT

A device, system and method may simulate a virtual model or modeling platform. A device, system and method for simulating a physical system such as a virtual simulation, living being, machine, etc., is capable of placing a set of virtual objects into a virtual work space, the virtual work space typically having a set of global definitions, simulating the interaction of the virtual objects and virtual work space, and displaying the simulated interaction. The device, system and method may include the capability of authoring a virtual simulation or experiment. A device, system or method may define a set of virtual objects and a virtual work space, the virtual objects having object parameters and the virtual work space having a set of global parameters, and place into a simulation data file the virtual experiment objects and said virtual work space. A student or researcher may conduct a virtual experiment using a computer system.

### RELATED APPLICATIONS

This application is a continuation in part claiming priority from the International Application filed on Aug. 13, 2002 and entitled, “A SYSTEM AND METHOD FOR SIMULATING A LABORATORY EXPERIMENT,” serial number not yet assigned, and U.S. application Ser. No. 10/217,331 filed on Aug. 13, 2002 and entitled, “A SYSTEM AND METHOD FOR SIMULATING A LABORATORY EXPERIMENT,” both of which in turn claim priority from U.S. Provisional Patent Application No. 60/311,800, filed on Aug. 13, 2001, all three applications being hereby incorporated by reference in their entirety.

### FIELD OF THE INVENTION

The present invention relates to the field of virtual presentation systems. More specifically, the present invention relates to a system and method for simulating a physical system such as, for example, a laboratory experiment, a human body, a cell, etc., in a virtual computer environment.

### BACKGROUND OF THE INVENTION

Repetitive experimentation has been the cornerstone of scientific research since mankind first began to attempt to alter its environment. Guided experimentation has become one tool used by educators to train young minds to think in scientific terms. Instructors in scientific fields (e.g. high-school or college instructors in chemistry, physics or biology, etc.) often perform demonstrations of chemical reactions or physical phenomenon to a group of students. The instructor may request that the students attempt the experiment.

For the most part, experiments performed by students are well defined and their results predictable and well understood. However, execution of these experiments by the students may often be cumbersome, messy, costly, and hazardous. Broken chemical containers or other objects, spilt chemicals, burned clothing, and destroyed instrumentation are only some of the factors which male student experimentation an unattractive option for a science instructor. In certain cases, the cost of providing one or more students with an experiment to perform may not be justified.

It is of course desirable for students, engineers, and researchers to model other physical systems, such as, for example, biological systems (a human body, a cell, etc.), large scale experiments (wind tunnels, etc.), buildings, or other systems. Computer systems do exist for modeling some of such systems, but are typically expensive and require training or special expertise to use. In other areas of technology or engineering, computer modeling systems may not exist. Further, such systems are typically designed for specific tasks, and are typically unable to be used or adapted for general experimentation or modeling.

Therefore, it may be beneficial to provide for an improved system and method of modeling physical systems. It would be desirable also to avoid the cost, mess, hazard, and other negative aspects of current experimentation and modeling. It would be desirable to provide a system capable of general experimentation or modeling, in a variety of fields.

### SUMMARY OF THE INVENTION

Embodiments of the present invention provide for a virtual simulation or experimentation and modeling platform. In one embodiment of the present invention, a device, system and method for simulating a physical system such as a virtual simulation or experiment, living being, machine, building, etc., is capable of placing a set of virtual objects into a virtual work space, the virtual work space typically having a set of global definitions, simulating the interaction of the virtual objects and virtual work space, and displaying the simulated interaction. Embodiments may include the capability of authoring a virtual simulation or experiment. A device, system or method may define a set of virtual objects and a virtual work space, the virtual objects having object parameters and the virtual work space having a set of global parameters, and place into a simulation data file the virtual experiment or simulation objects and said virtual work space. A student or researcher may conduct a virtual experiment using a computer system.

### BRIEF DESCRIPTION OF THE DRAWINGS

The subject matter regarded as the invention is particularly pointed out and distinctly claimed in the concluding portion of the specification. The invention, however, both as to organization and method of operation, together with containers, features, and advantages thereof, may best be understood by reference to the following detailed description when read with the accompanying drawings in which:

FIG. 1 is a block diagram illustration of an embodiment of a virtual simulation platform according to an embodiment of the present invention;

FIGS. 2A and 2B depict a block diagram of certain functional blocks of an embodiment of the present invention;

FIG. 3 is a depiction of a screen of a computer application according to an embodiment of the present invention; and

FIG. 4 depicts an object data structure according to one embodiment;

FIG. 5 depicts a workspace data structure according to one embodiment;

FIG. 6 depicts a student notebook according to an embodiment of the present invention;

FIG. 7 depicts a data flow according to one embodiment of the present invention;

FIG. 8 is a flow chart depicting a method according to one embodiment of the present invention;

FIG. 9 is a block diagram of an experiment runtime application according to an embodiment of the present invention; and

FIG. 10 is a flow chart depicting a method according to one embodiment of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. This apparatus may be specially constructed for the desired purposes, or it may include one or more general purpose computer(s) selectively activated or reconfigured by one or more computer program(s) stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus.

The processes and displays presented herein are not inherently related to any particular computer or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the inventions as described herein.

Embodiments of the present invention provide for a virtual simulation or experimentation or modeling platform including, for example a virtual simulation authoring application and a virtual experiment presentation application. A set of virtual experiment or simulation objects (where set can include one unit), each object typically including, for example, a data structure with at least one parameter defining a physical characteristic of the virtual experiment object, may be placed within a virtual work space in an arrangement defining an initial state of a system formed by the set of virtual experiment objects. The virtual work space may include parameters and definitions.

In one embodiment, a translation module inputs the state of the system and creates a set of rules. A simulation engine creates a real time simulation based on these rules. A display module displays the simulation for a user.

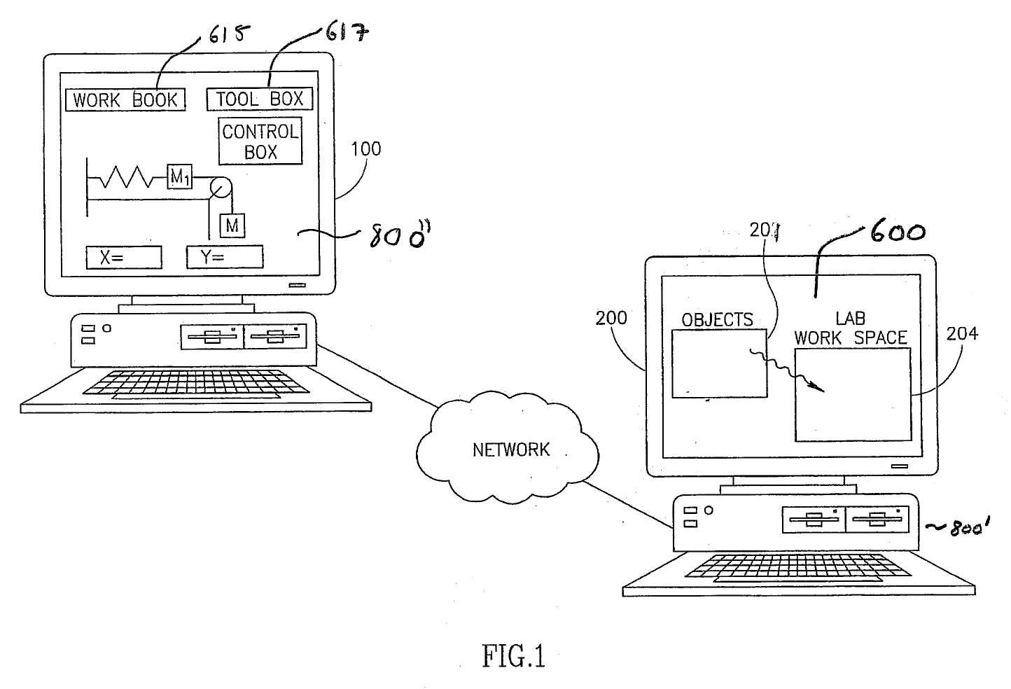

Referring to FIG. 1, there is shown an embodiment of a virtual simulation or experimentation or modeling platform according to an embodiment of the present invention. A student workstation 100 is connected to an instructor workstation 200 over, for example, a data network (e.g., a LAN, the Internet, etc). In some embodiments of the present invention, however, the instructor workstation 200 and the student workstation 100 may be the same computer. Each workstation 100 and 200 may be, for example, a personal computer, a workstation, a terminal, etc., or any other type of computing device, such as a hand held device. Typically, each workstation 100 and 200 includes known components such as a processor (e.g., CPU, microprocessor, etc.), one or more memories (e.g., RAM, ROM, etc), mass storage (e.g., hard disk, CD-ROM, etc.), an operating system, and other known components. More than one instructor workstation 200 and more than one student workstation 100 may be used. Further, some components or data structures may be stored on a server (not shown).

An instructor may use, for example an authoring application 600, described below, to design a virtual workspace 204 which includes virtual simulation objects 201. The virtual simulation workspace 204 may simulate a real world environment and may include one or more parameters indicative of a real world environment (e.g. gravity, temperature, humidity, atmosphere, etc.). The student may use, for example, a simulation runtime application 800, described below, to conduct experiments in the virtual workspace 204 using the simulation objects 201. A toolbox 617 may contain, for example, simulation objects 201. A workbook 615 may, for example, allow a user to store experimental results. The various users may manipulate the virtual workspace 204, simulation objects 201, and other items using known graphical user interface (“GUI”) methods. For example, objects 201 may be placed and arranged inside the virtual workspace 204 using “drag and drop” functionality, well known in most GUIs, and in the Windows operating system.

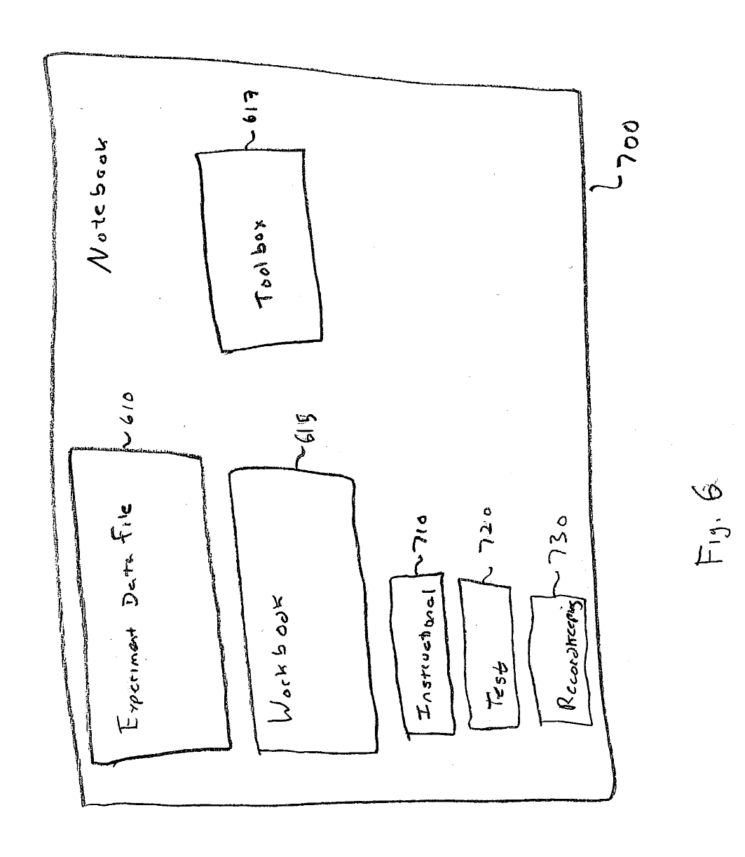

A student using the student workstation 100 and running (typically remotely) a simulation runtime application 800 may simulate an experiment arranged by an instructor. Simulation runtime application 800 is represented in FIG. 1 by an experiment runtime application client 800′ and an experiment runtime application server 800″. Experiment runtime application client 800′ running on the student workstation 100 may exchange data with an experiment runtime application server 800″, which may receive a notebook 700 (see, e.g., FIG. 6). The notebook 700 may contain, for example, data describing virtual simulation objects 201, instructions on, for example, how to run the experiment, etc. In some embodiments of the present invention, the notebook 700 may not contain instructions on how to display the objects 201, but rather may contain written instructions to the student regarding how to arrange the objects 201 within the virtual simulation workspace 204, thereby having the student contribute to the experiment. While in FIG. 1 experiment runtime application server 800″ runs on the same workstation as an authoring application 600, experiment runtime application server 800″ may be run from another computer or workstation, such as a server.

In one embodiment, experiment runtime application client 800′ is or includes a suitably configured Internet browser, and communicates by conventional network and Internet methods with experiment runtime application server 800″. Other client/server models may be used. In further embodiments, experiment runtime application client 800 may not be embodied using a client/server model. For example, simulation runtime application 800 may operate on the student workstation 100 substantially in its entirety.

Although FIG. 1 shows an embodiment of the present invention in terms of two separate workstations running, it should be understood that the virtual experiment or simulation system and method of embodiments the present invention may also be implemented using a single computer or computing unit or a larger network of computers. Furthermore, the various functional units and applications of the various embodiments of the present invention may be implemented different manners, and their functionality divided in different manners, across other computing systems.

In alternate embodiments, systems other than virtual experiments may be modeled, such as living beings, machines, buildings, etc. An instructor/student model, as shown in FIG. 1, need not be used or needed.

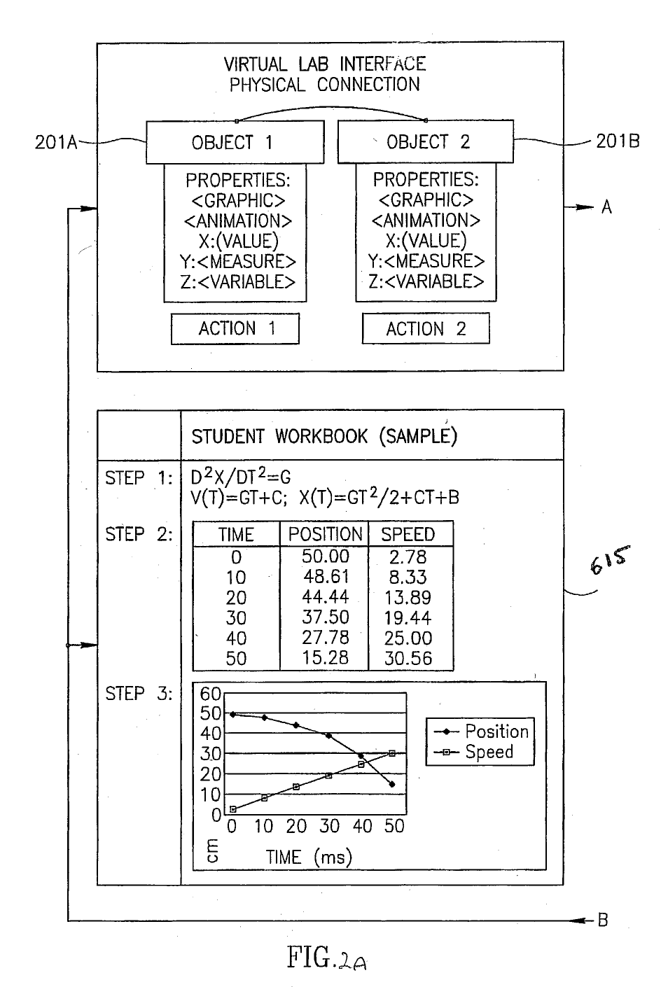

Referring to FIGS. 2a and 2b, there is shown a conceptual block diagram of certain functional blocks of an embodiment of the present invention. These functional blocks may interact with one another within a single computing device or across a distributed network. For example, virtual simulation objects 201a and 201b may be functionally associated or linked to one another in a virtual workspace 204. A workbook 615, may, for example, allow a user to store experimental results and other data.

A translation module 110 may accept an initial or other state of the system (e.g., the state of virtual workspace 204, which objects 201 are in virtual workspace 204, the properties and relationships of these objects 201, etc.), and, based on basic rules about the physical systems involved, output a set of interaction rules (e.g., rules, subroutines, algorithms, etc.) for a simulation engine 112 to use. The interaction rules may define the ways in which the objects 201 and workspace 204 are to interact, and may include, for example, software routines, rules written in a certain notation (e.g., formulas according to physics conventions, etc), or other rules or algorithms. The rules about the physical systems may vary based on the physical system to be modeled. For example, a physics or chemistry experiment application may include basic physics and chemistry rules, and a biology based application may include rules regarding the interaction of cell structures and substances. The state of the system may include, for example, the time elapsed since the start of an experiment or simulation. The information accepted by the translation module may be in the form of, for example, a simulation data file 610 (discussed below); other data structures and formats may be used.

Typically, a system including multiple objects interacting with one another may be defined by a mathematical model having multiple simultaneous equations. Translation module 110 may solve these multiple simultaneous equations for specific conditions which may for example be defined by the student, or which may be generated by a number generator. Various mathematical modeling systems and applications are well known. Computer applications which may solve complex series of equations and may display the results for multiple input values or conditions are well known (e.g. MatLab, Mathentica, etc.).

A simulation engine 112 accepts the output from the translation module 110 and runs the simulation. The simulation engine 112 iteratively alters the state of the virtual workspace 204 and objects 201, per the rules and/or algorithms provided by the translation module 110 and per the current state of the overall system. Such a simulation may occur over time, using certain time slices. For example, the simulation engine 112 may alter the state of the system according to a 100^{th} of a second time slice. The state of the system may be fed back to the simulation engine 112 for each iteration. The simulation engine 112 may calculate results for various parameters of the system formed by the virtual experiment or simulation objects over a period of time, which may influence the state of the system. In some embodiments of the present invention, a student or user may control the variable factors affecting the system and may monitor the result from the simulation engine.

A display module 114 may take the output of the simulation engine 112 and display the output to a user. Standard GUI methods may be used. In one embodiment, each iteration is sent to the display module 114 from the simulation engine 112. Each iteration (or a set of iterations, if the iteration time slice is less than the display time slice) may cause the display module 114 to alter the display presented to the user. The experiment or the changing physical system is presented to the user.

Certain changes to the overall state of the system may cause the translation module 110 to alter the rules, algorithms, etc. output to the simulation engine 112. For example, a user adding or removing an object 201, altering a setting or property of an object 201 (e.g., a temperature setting on a cooler, an acidity level) may cause the translation module 110 to recalculate and transmit an output to the simulation engine 112. During a simulation, objects may be created or destroyed—for example, two chemicals may combine to create a third.

In alternate embodiments, other modules or sets of modules may perform the functionality described herein, and the functionality may be combined in one or other numbers of modules.

Each of the virtual simulation objects 201 may represent a tangible object which for example participates in an experiment, acts as a catalyst, or is used to measure aspects of the experiment, etc. A virtual simulation object 201 may be, for example, a chemical, a composite material, a measuring instrument, a device used as part of an actual experiment, etc.

Virtual experimental objects 201 may be positioned in the virtual simulation workspace 204 in an arrangement corresponding to an arrangement that actual or real objects, which the virtual objects 201 are meant to represent, would have in an actual or real experiment. Virtual experimental objects 201 may be linked with relationship tags, such as relative positions, more complex relationships such as “within” or “on”, or other relationships. For example a virtual object 201 representing a container may be linked with a virtual object 201 representing an amount of water so that the container holds the water. The virtual simulation objects 201 may be arranged and associated or linked to one another, or relationships may be defined among objects 201, within the virtual workspace 204 so as to depict an actual experiment (e.g. a physics experiment, a chemistry experiment, an optics experiment etc.). Various user indications may define such relationships, associations or links. Virtual simulation objects 201 arranged within the virtual simulation workspace 204 may form a virtual “system” corresponding to a real “system” (a term used in science to define a group of objects interacting with one another in isolation from other objects) formed by real objects linked to one another in the real world.

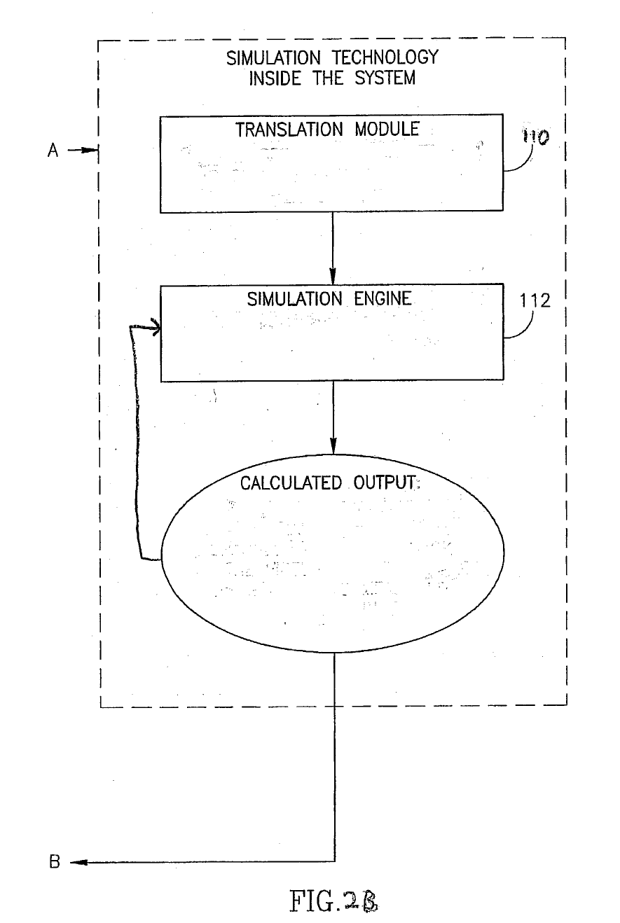

Referring to FIG. 3, there is shown a screen produced by a computer application according to some embodiments of the present invention, where on the top left portion of the screen there is visible a visual representation of an experiment database 650 of virtual experiment or simulation objects, 201a to 201c, which may be placed inside the virtual workspace 204. Also visible are objects 201 placed in the workspace 204 in an arrangement simulating an actual experiment.

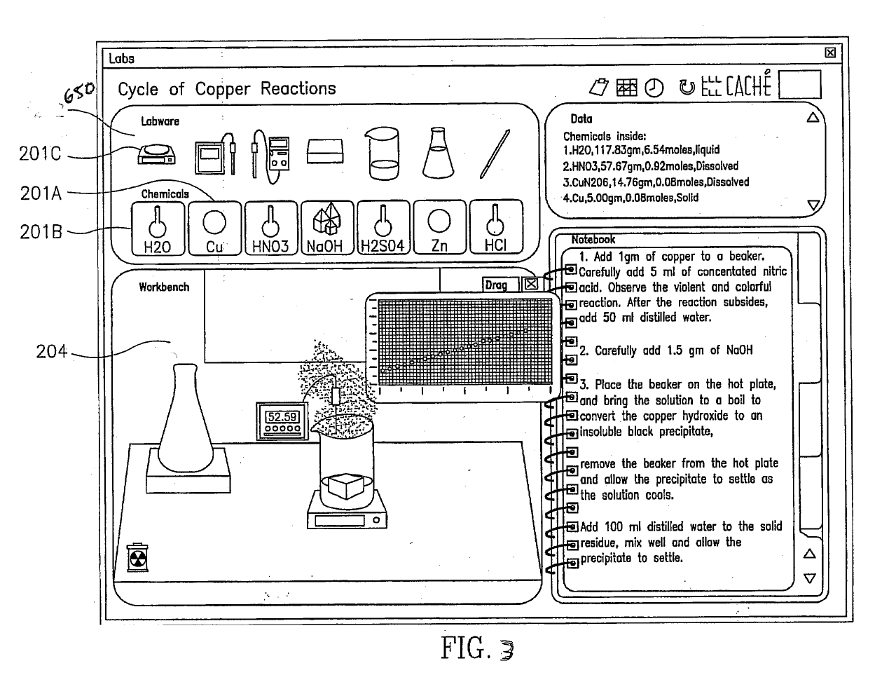

Each of the virtual simulation objects 201 may be represented by at least one object data structure 300, which may store, for example, various parameters or characteristics indicative of the real life object the virtual simulation object 201 is meant to represent. FIG. 4 depicts an object data structure according to one embodiment. Referring to FIG. 4, in one embodiment, an object data structure 300 includes, for example, an object title 302, and a set of object properties 304. Object properties 304 may include, for example, physical, functional, and descriptive characteristics, screen display and position data, and possibly other data. For example, if the virtual simulation object 201 is a chemical element, the object properties 304 may contain parameters such as the element's atomic weight, reaction properties, an image representation of the elements, etc. If the virtual simulation object 201 represents an instrument or measuring device, the associated the object properties 304 may contain one or more parameters defining the instrument or device's operational features.

An object data structure 300 may include information on relationships, defining links or relationships among virtual objects 201 and workspace 204. The connected or linked objects 201 within the virtual simulation workspace 204 may form a virtual representation of a real “system”. In one embodiment, the object data structure 300 of certain objects includes a data structure including links to other objects 201 that are in, on, or connected to the object 201. In a typical embodiment, the objects 201 holding such link or association information are one class of objects such as “tool” objects; other classes or types of objects may be used. A data structure such as connected array 310 in an object data structure 300 corresponding to an object 201 may hold links to other object data structures 300 corresponding to other objects 201. More than one connected array per object may be used—for example, a connected array corresponding to materials (e.g., chemicals, substances), a connected array corresponding to tools (e.g., thermometers), etc. Other methods or systems for connecting or associating objects may be used.

Physical characteristics may include for example, if suitable for the object, an object's shape or appearance, the object's chemical structure, etc. Functional characteristics may include, for example, the object's interaction characteristics with other materials, chemicals, etc., the object's properties under various environmental conditions, such as pressure, temperature, etc. Descriptive characteristics may include, for example, the current temperature of the object. Other data may be included in object data structure 300. Objects 201 and object data structures 300 may include items beyond, for example, beakers, weights and chemicals. For example, tools and measuring instruments may be represented. Depending on the application, an object may be a cell, an enzyme, a moving part, a piece of a machine or building, etc. Scientific laws or rules, such as material scientific laws, tool scientific laws, etc, may be included in, for example, object data structure 300, but may be included in another data structure.

In one embodiment, a user may be able to alter the settings on such equipment when added to an experiment. For example, clicking or positioning a pointing device (e.g., using a mouse) over the graphical representation of a cooling device may present a window with attributes, and the user may change some of these attributes, for example altering the temperature setting.

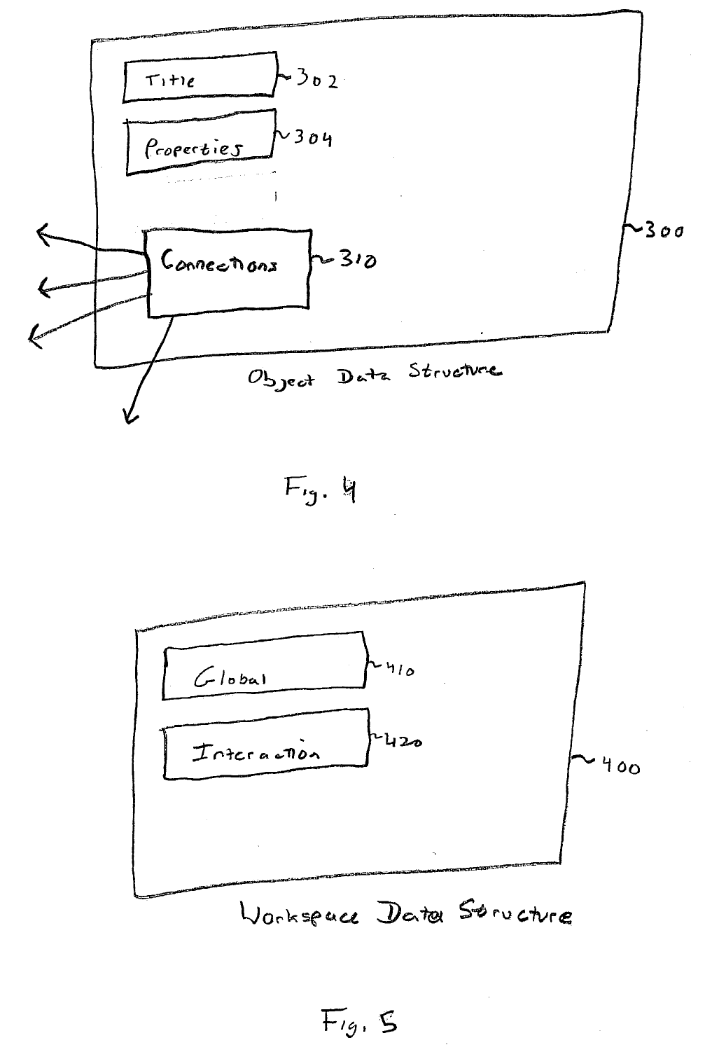

FIG. 5 depicts a workspace data structure according to one embodiment. Referring to FIG. 5, in one embodiment, a workspace data structure 400 includes definitions and descriptions for the virtual simulation workspace 204. For example, workspace data structure 400 may include global definitions or parameters 410 and interaction definitions or parameters 420. Global definitions 410 may include, for example, the pressure, temperature, or chemical makeup (e.g., atmosphere) of the workspace 204. Interaction definitions 420 may include, for example, rules as to how the workspace 204 and its characteristics interact with and cause changes to the workspace 204 and objects 201. Typically, interaction definitions 420 act in conjunction with data from global definitions 410. For example, if per a global definition 410 the temperature of the workspace 204 is −10 degrees Celsius, and object 201 which is distilled water may freeze; if per a global definition 410 the temperature of the workspace 204 is 10 degrees Celsius, the same object 201 may be liquid. Other data may be included in workspace data structure 400. Depending on the specific application, a workspace may be, for example, a living body, an outdoor environment, etc.

FIG. 6 depicts a student notebook according to an embodiment of the present invention. Referring to FIG. 6, a notebook 700 may be created by, for example, authoring application 600, and distributed to students. Other methods for creating a notebook may be used, and student data need not be stored in a notebook. The notebook 700 may provide the data and tools for the student to perform the experiments, and may collect data and control information (e.g., attendance information, etc.) for the instructor. For example, a notebook 700 may contain a simulation data file 610, workbook 615 (which may, for example, store experimental results for the benefit of the student and possibly instructor, possibly including the time and number or times an experiment was conducted), and instructional information 710 such as lab technique explanations, explanatory photos or videos, lab manuals, safety information, photos and/or videos, links to online materials, review materials, lecture notes, etc. A toolbox 617 may contain, for example, simulation objects 201. A notebook 700 may contain, for example, sample or required test material 720, including, for example, practice quizzes, and tests, and pre-lab exercises. The student may be required to execute or complete sample or required test material 720 (e.g., do exercises, separate from completing a lab or experiment) and send the results to the instructor. Such test material 720 may also be optional. A notebook 700 may include recordkeeping data 730, which may record, for example, attendance data, test result data, etc.

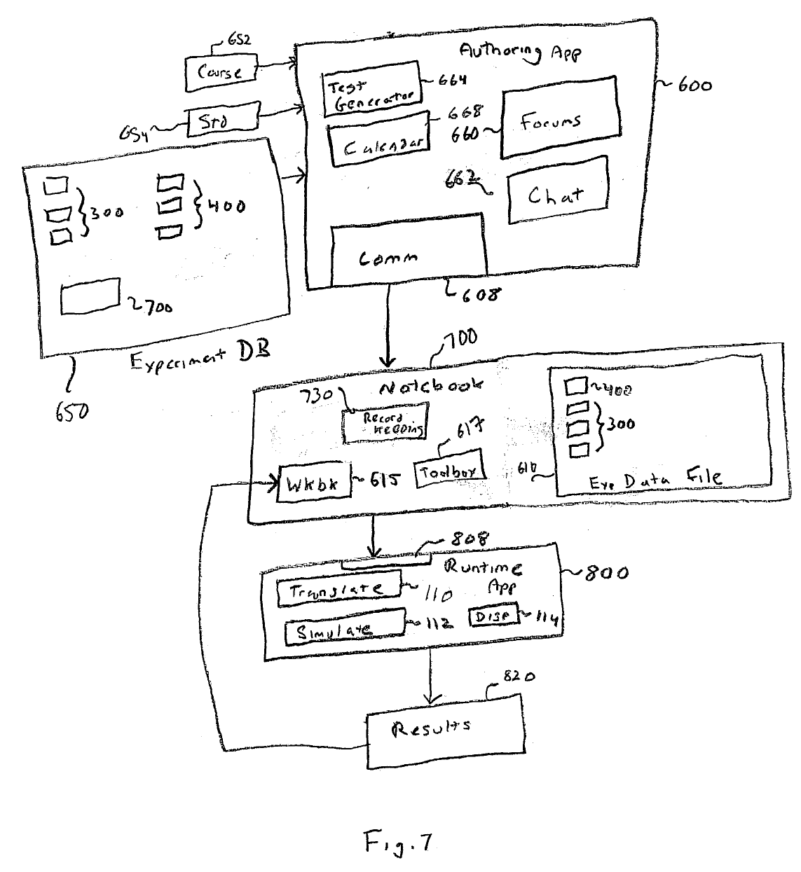

FIG. 7 depicts a data flow according to one embodiment of the present invention. Referring to FIG. 7, an instructor may use an authoring application 600, taking as input, for example, an experiment database 650 of object data structures 300 and one or more workspace data structures 400, and create a notebook 700 including, for example, a simulation data file 610 and possibly other data (e.g., instructions, tests, etc.). A simulation data file 610 may contain, for example, simulation objects 201 (represented by object data structures 300), a workspace 104 (represented by workspace data structure 400), and other structures, such as structures allowing for student reporting or monitoring of students. A simulation data file 610 may contain, for example, a toolbox 617 and a workbook 615, which may, for example, allow a user to store experimental results.

Authoring application 600 may include (or may accept) various databases and functionalities which may include, for example, tools for creating, running and managing experiments, course management tools, student control/tracking tools (e.g., enrollment, attendance, grading, etc.), and other functions. For example, experiment database 650 may include the data required for creation of notebooks 700 (e.g., object data structures 300, workspace data structures 400, and other data, instructions, etc.) and possibly the notebooks 700 themselves. Authoring application 600 may include (or may accept) a course management database 652 which may include data related to the construction of a course, such as manuals, curricula, tests and quizzes or tests and quiz data, etc. Student database 654 may include, for example, student enrollment, attendance, grade books, and other records pertinent to students. Authoring application 600 may include tools for interaction among students and/or instructors, such as forums and discussion areas 660 and/or chat areas 662 which may be used for, for example, tutoring. Known methods for electronic discussion or chat functions may be used. Authoring application 600 may include other tools such as a quiz/test generator 664, and a calendar 668 for, for example, scheduling events and limiting the availability of quizzes, tests, exercises and virtual labs. Authoring application 600 may include the functionality to create new objects 201 or new rules or processes. For example, a user may use authoring application 600 to create a new element or chemical, a new item of machinery, a new drug, etc.

Authoring application 600, simulation runtime application 800 and other units in the system may integrate or operate on various types of media, for example, graphics, text, audio, video, URL links, etc.

An instructor may, for example, use an authoring application 600 to create or edit structures used in experiments, such as object data structures 300 and workspace data structures 400. The instructor may take as input a “standard” or pre-set set of object data structures 300 (representing, e.g., standard objects such as oxygen, a 500 ml beaker, etc.) and workspace data structures 400, may modify these structures, and may create new such structures. For example, and instructor may create or alter containers, tools, chemicals, measuring instruments, etc., defining them as objects 201. The instructor may combine such objects into a simulation data file 610. A simulation data file 610 may be edited, copied, stored, exported, shared with other instructors, sent to students, etc. An instructor may “lock” or prevent the student from modifying certain or all aspects of the simulation data file 610. For example, the properties of the object data structures 300 and workspace data structures 400 may be unchangeable by the students. In a further level of restriction, the positions and relationships among the object data structures 300 and workspace data structures 400 may be unchangeable by the students.

In alternate embodiments or applications, if a student/instructor model is not used (e.g., a system intended for a researcher), elements geared towards student-instructor interaction and monitoring may be eliminated.

The authoring application 600 may place into the notebook 700 instructions on, for example, how to arrange the objects 201 in a virtual simulation workspace 204, or what are or should be the links, relationships or connections between the objects 201. A communication module 608 located within the authoring application 600 may package data and send it as, for example, notebook 700 directly to students, to a storage area (not shown) from which one or more students may retrieve it, or to other destinations.

Notebook 700 may be sent to students, who may, for example, use a simulation runtime application 800 to operate on simulation data file 610. The runtime application 800 may include, for example, a communication module 808, which may access or retrieve a notebook 700, including, for example, a simulation data file 610. Alternately, if the runtime application 800 is integrated with the authoring application 600 or other software, a communications module need not be used.

Simulation runtime application 800 typically includes at least a translation module 110, a simulation engine 112, and a display module 114. Alternately, students may have a previously created notebook 700, and the instructor may create and send sub-data (e.g. simulation data file 610) to the student for inclusion within the notebook 700. Other data structures, other data, and other methods of organizing the data may be used. For example, a simulation data file or notebook need not be used. Further, other processes and methods may be used to perform the methods or embody the device and system of the present invention. For example, a translation module, display module and simulation engine need not be used, the functionality of these modules may differ, or the functionality of these modules may be embodied in other modules.

Notebook 700 may be modified or manipulated by a student using simulation runtime application 800, within limits set by the instructor. For example, simulation runtime application 800 may be used to place or move virtual simulation objects 201 in virtual workspace 204.

Runtime application 800 may include a translation module 110, display module 114 and simulation engine 112. Translation module 110 typically accepts simulation data file 610 (possibly modified or manipulated by the student) and possibly other information and outputs a set of rules, subroutines, or algorithms for a simulation engine 112 to use. Simulation engine 112 accepts the output from the translation module 110 and runs the simulation. A display module 114 may, for example, display to the user the results of the interactions among the objects 201 and workspace 204, for example, on a GUI. The presentation may include a simulated interaction among the object(s) 201 and workspace 204. The simulation engine 112 changes the parameters of the object(s) 201 over time, and sends output to the display module 114 for redisplay. The results may be seen as a change in for example the position or some other feature of the objects 201 displayed therein.

Referring to FIG. 7, runtime application 800 may produce an experimental results data set 820, which may, for example, be stored in the notebook 700 (e.g., in a workbook 615) for later use by the student or instructor. Runtime application 800 may store other data, such as when and how many times experiments were conducted, in notebook 700 as recordkeeping data 730. Additional calculations, based on the results, may be performed. In FIG. 2A there is shown a numerical table and graph within the workbook 615 in the context of a spring experiment.

Typically, applications and data items such as translation module 110, simulation engine 112, display module 114, runtime application 800, authoring application 600, notebook 700, experiment database 650 of object data structures 300, workspace data structures 400, and other data and applications, exist as appropriate software modules, data structures and databases in, for example, workstations 100 and 200 (FIG. 1). The structure and functionality of such modules and data structures may differ across embodiments. Known methods of creating and storing data structures such as those described herein may be used. For example, the notebook 700 and its components may be stored in one or more databases, and may be represented as, for example, object oriented objects or as other data structure. For example, simulation objects which are used by a user may be “live” objects which inherit properties from other object oriented objects. In one embodiment, the various data structures and functional modules are embodied using object oriented systems such as C++ and database systems such as Caché by InterSystems. In addition, JavaScript and Flash, by Macromedia, are used in an exemplary embodiment.

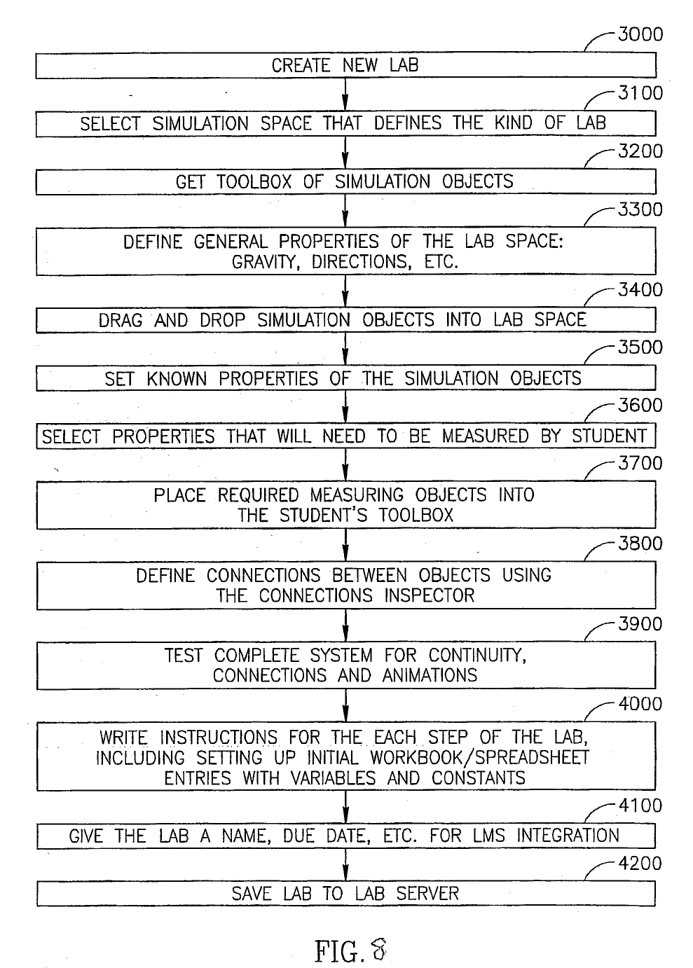

Referring to FIG. 8, there is shown flow chart depicting a method according to one embodiment, which may be performed using, for example an experiment authoring application according to an embodiment of the present invention. Referring to FIG. 8, in step 3000, a user may create a new virtual lab. In step 3100, a user may select a simulation space that defines the kind of lab which is desired for the experiment. In step 3200, the application may receive or input a toolbox (database) with simulation or virtual experiment objects. In step 3300, a user may define general or global properties of the lab space (e.g. gravity, temperature, etc.).

In step 3400, in order to author an experiment, once the preliminary steps are taken, a user may drag and drop objects in the lab workspace. Standard GUI techniques may be used. In one embodiment, each object 201 may include both an icon or other visual representation, and also a window listing certain characteristics of the object 201 (e.g., an amount of material, a pH, a temperature, a desired setting on an item of equipment, a motor speed, a voltage) and allowing a user to alter certain of these characteristics. For example, a user may first drag an object 201 representing a beaker into the workspace; while dropping the object the user may be asked to assign or pick a size for the beaker, via a window appearing on the GUI. A user may then add a chemical substance to the beaker, by dragging an object 201 representing the substance over the beaker icon. While dropping the object 201 the user may be asked to assign or pick an amount of material to be placed in the beaker, via a window appearing on the GUI. The user may place the beaker in an item of cooling equipment represented by an object 201; the user may alter the temperature setting on the cooler via a window. The preceding merely provides a set of examples; other methods of manipulating and controlling objects 201 may be used.

In step 3100, a user may set properties (e.g. mass, temperature, etc.) of the objects. In step 3600, a user selects properties needed to be measured or determined by a student during the experiment. In step 3700, a user may place measuring objects into a toolbox 3700. In step 3800, a user may define connections between objects 3800, and save or transmit the experiment (e.g. the lab or experiment file) to a location accessible by one or more students.

In step 3900, a user may test the system for, for example, continuity, connections and animations. In step 4000, a user may write instructions for the steps of the experiment. The user may also setup an initial workbook or spreadsheet. In step 4100, administrative details such as a name, due date, etc., may be used. In step 4200, the user may, for example, save the lab to a server, transmit the lab to students, etc. Other steps or series of steps may be used. While in one embodiment, integration with a learning management software (LMS) application may be used; in alternate embodiments other databases may be used.

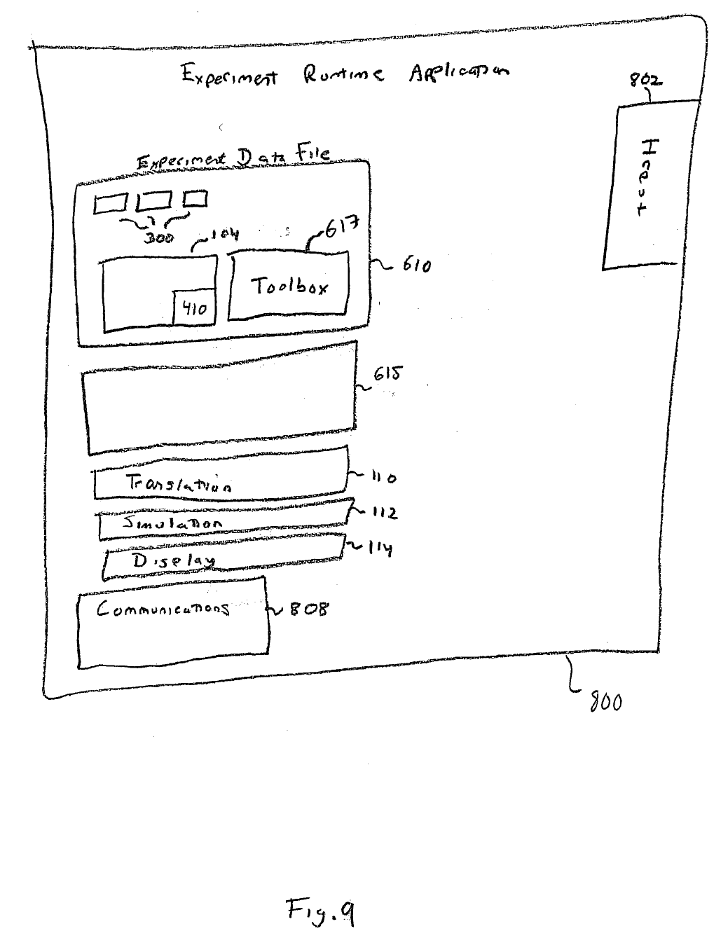

Referring to FIG. 9, there is shown a block diagram of a simulation runtime application 800 according to an embodiment of the present invention. The runtime application 800 may include, for example, a communication module 808. A simulation data file 610 may contain, for example, virtual simulation objects 201 (represented by object data structures 300). In one embodiment, a portion of virtual simulation objects 201 may be placed within a virtual lab work area or workspace 104, and another portion may be placed in, for example, a toolbox 617. Typically, objects 201 participating in the experiment, forming the system to be modeled, are placed in the workspace 104. Instrumentations or measuring device objects 201 may be placed, for example, within the toolbox 617, and a user may then place the instrumentation objects(s) 201 in selected positions within the virtual workspace 104. In one embodiment, a simulation runtime application 800 is divided among an experiment runtime application client 800′ and an experiment runtime application server 800″. The experiment runtime application server 800′ performs the bulk of the processing, and includes a translation module 110 and a simulation engine 112. The display module 114 may be divided between the experiment runtime application client 800′ and an experiment runtime application server 800″. Alternately, a client/server model need not be used.

A user input module 802 may receive input from a user of the runtime application 800 and may apply the input to various parameters of the virtual experiment. For example, the user input module 802 may allow a user to change for example global definitions or parameters 410 of the environment simulated in the virtual workspace 104 or specific parameters (e.g. mass) of specific virtual simulation objects 201. The user input module 802 may also allow a user to enter and modify data and formulas in a workbook 615. The workbook 615 may include, for example, an application with rows and columns where data may be entered, tabulated, manipulated and where calculations may be performed.

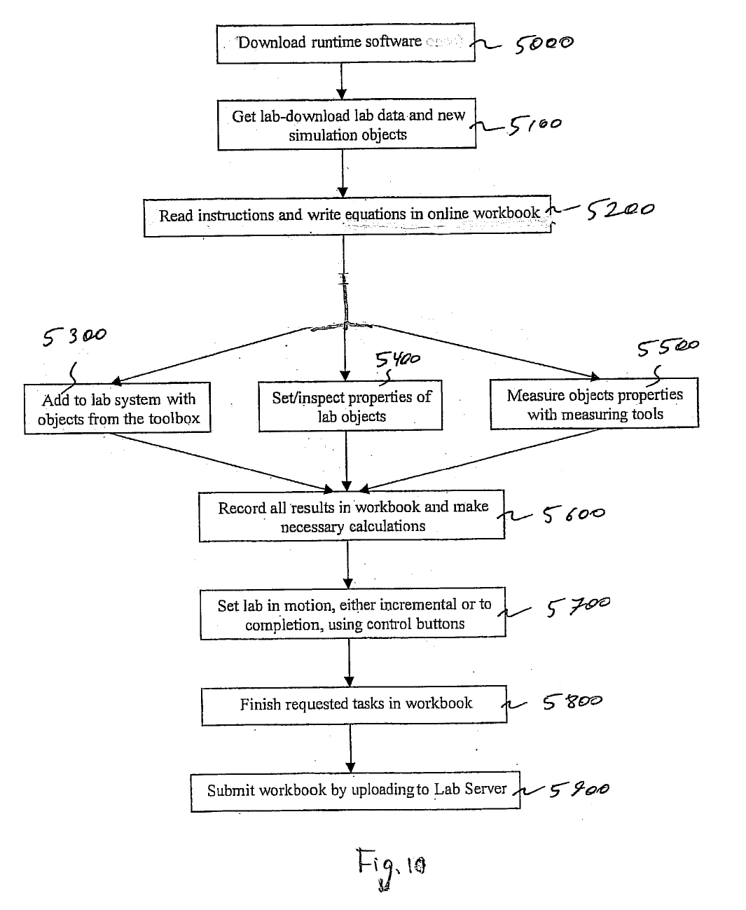

FIG. 10 is a flow chart illustration of the method of executing a student runtime application in accordance with an embodiment of the present invention. Referring to FIG. 10, in step 5000, student may download and install the runtime software to enable the execution of the virtual lab on the student's workstation. Block 5000 may be omitted if it is not necessary to download and/or install the run time software on the student's workstation. In step 5100, lab data and new simulation objects may be obtained. For example, a student may download or otherwise access a notebook 700, or other data.

In step 5200, the student may read instructions and, for example, write a set of modeled equations in an online workbook. In step 5300, the student may elect, or the student may be required, to add objects to workspace from the toolbox. In step 5400, the student may elect, or the student may be required, to set or inspect properties of lab objects. In step 5500, the student may elect, or the student may be required, to measure object properties with measuring tools.

In step 5600, some or all of the results of the experiment may be recorded in, for example, the workbook 615 and calculations may be performed. In step 5700, the lab simulation or experiment may be executed, setting the lab in motion. The lab may be “set in motion” when the user signals experiment runtime application input module 800. The lab simulation may be for example incremental or may be run from an initial state to completing, and may be controlled by, for example, an experiment runtime application input module 802. In step 5800, the results may be recorded in, for example, the student's workbook 615. In step 5900, the workbook 615 may be submitted, for example by uploading the workbook 615 to a lab server or other digital storage space from which it may be retrieve by an instructor. Other steps or series of steps may be used.

Embodiments of a system and method according to an embodiment of the present invention are adaptable or usable in various areas of technology or engineering, and for various purposes. For example, the student tracking aspects may be omitted in an embodiment used by researchers. Other embodiments may allow an instructor or researcher to construct a modeling system for use in various fields—physics, medicine, civil engineering, etc. Thus, such a system may be distributed to various engineers, researchers or instructors, and the particular user may adapt the system for their particular need.

For example, a virtual workspace 204 may be adaptable by a user or software designer to represent the environment of a building, a living being, a physics experiment for students, a wind tunnel, etc. A user or software designer may create or design virtual simulation objects 201 to be, for example, cells, proteins, vehicles, building components, laboratory tools, etc.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. A method for simulating a virtual simulation, the method comprising:
placing a set of virtual simulation objects into a virtual work space, the virtual work space having a set of global definitions;
simulating the interaction of the virtual simulation objects and virtual work space; and
displaying the simulated interaction.

2. The method of claim 1, wherein each virtual simulation object includes a set of parameters, the method comprising:
accepting parameters for each virtual simulation object and the global definitions; and
preparing a set of interaction rules.

3. The method of claim 1, wherein each virtual simulation object includes a set of parameters, the method comprising iteratively recalculating parameters for each virtual simulation object and the global definitions.

4. The method of claim 1 comprising defining relationships between at least two virtual simulation objects by placing the objects within the virtual environment.

5. The method of claim 1 wherein each virtual simulation object includes a set of object properties.

6. The method of claim 1 wherein the global definitions include a set of interaction definitions.

7. The method of claim 1, wherein the virtual simulation is a student experiment.

8. The method of claim 1, wherein the virtual simulation is a simulation of a physical system.

9. A system for simulating a virtual simulation, the system comprising:
a controller capable of:
accepting a set of virtual simulation objects and placing the objects into a virtual work space, the virtual work space having a set of global definitions;
simulating the interaction of the virtual simulation objects and virtual work space; and
displaying the simulated interaction.

10. The system of claim 9, wherein each virtual simulation object includes a set of parameters, the controller capable of:
accepting parameters for each virtual simulation object and the global definitions; and
preparing a set of interaction rules.

11. The system of claim 9, wherein each virtual simulation object includes a set of parameters, the controller capable of iteratively recalculating parameters for each virtual simulation object and the global definitions.

12. The system of claim 9 wherein the controller is capable of defining relationships between at least two virtual simulation objects by placing the objects within the virtual environment.

13. The system of claim 9 wherein each virtual simulation object includes a set of object properties.

14. The system of claim 9 wherein the global definitions include a set of interaction definitions.

15. The system of claim 9, wherein the virtual simulation is a student experiment.

16. The system of claim 9, wherein the virtual simulation is a simulation of a physical system.

17. A method for authoring a virtual simulation, the method comprising:
defining one or more virtual simulation objects and a virtual work space, the virtual simulation objects having object parameters and the virtual work space having a set of global parameters; and
placing into a simulation data file said one or more virtual simulation objects and said virtual work space.

18. The method of claim 17 comprising placing into the simulation data file a set of security restrictions.

19. The method of claim 17, wherein at least one virtual simulation object is taken from a pre-set database of virtual simulation objects.

20. The method of claim 17, comprising placing into the simulation data file an instructor recordkeeping structure.

21. A system for authoring a virtual simulation, the system comprising:
a controller capable of:
defining one or more virtual simulation objects and a virtual work space, the virtual simulation objects having object parameters and the virtual work space having a set of global parameters; and
placing into a simulation data file said one or more virtual simulation objects and said virtual work space.

22. The system of claim 21 wherein the controller is capable of placing into the simulation data file a set of security restrictions.

23. The system of claim 21, wherein at least one virtual simulation object is taken from a pre-set database of virtual simulation objects.

24. The system of claim 21, wherein the controller is capable of placing into the simulation data file an instructor recordkeeping structure.

25. A method of simulating a virtual simulation, the method comprising:
displaying a virtual simulation area, said virtual simulation area including at least one virtual simulation object, each of said at least one virtual simulation object including a parameter;
displaying said at least one virtual simulation object in an initial condition;
changing at least one parameter; and
displaying said at least one virtual simulation object according to said least one parameter.

26. The method of claim 25 comprising:
accepting virtual simulation object parameters; and
preparing a set of interaction rules.

27. The method of claim 25 comprising defining relationships between virtual simulation objects by placing the objects within the virtual simulation area.

28. The method of claim 25 wherein said virtual simulation area includes global definitions, said global definitions including a set of interaction definitions.

29. A system for simulating a virtual simulation, the system comprising:
a controller capable of:
displaying a virtual simulation area, said virtual simulation area including at least one virtual simulation object, each of said at least one virtual simulation object including a parameter;
displaying said at least one virtual simulation object in an initial condition;
changing at least one parameter; and
displaying said at least one virtual simulation object according to said least one parameter.

30. The system of claim 29 wherein the controller is capable of:
accepting virtual simulation object parameters; and
preparing a set of interaction rules.

31. The system of claim 29 wherein the controller is capable of defining relationships between at least two virtual simulation objects by placing the objects within the virtual simulation area.

32. The system of claim 29 wherein said virtual simulation area includes global definitions, said global definitions including a set of interaction definitions.

33. A data object for the simulation of a virtual simulation, the data object comprising:
a set of simulation objects, each object including a set of object parameters; and
a virtual workspace, the virtual workspace including a set of workspace parameters.

34. The data object of claim 33 wherein said workspace parameters include a set of interaction definitions.

35. The data object of claim 33 comprising a set of links linking the simulation objects.

36. A method for simulating a virtual simulation, the method comprising:
placing one or more virtual simulation objects into a virtual work space, the virtual work space having a set of global definitions;
accepting parameters for each virtual simulation object and the global definitions;
preparing a set of interaction rules; and
simulating the interaction of the virtual simulation objects and virtual work space.

37. A system for simulating a virtual simulation, the system comprising:
a controller capable of:
accepting a set of virtual simulation objects and placing the objects into a virtual work space, the virtual work space having a set of global definitions;
defining relationships between the virtual simulation objects; and
simulating the interaction of the virtual simulation objects and virtual work space.

38. A method of simulating a virtual simulation, the method comprising:
displaying a virtual simulation area, said virtual simulation area including a plurality of virtual simulation objects, each virtual simulation object including a parameter;
defining relationships between the virtual simulation objects by placing the objects within the virtual simulation area;
displaying said virtual simulation objects; and
performing a simulation using said virtual simulation objects.
